(19) United States
(12) Patent Application Publication
(10) Pub. No.: US 2012/0164041 A1
(43) Pub. Date: Jun. 28, 2012

(54) Stabilization of Arsenic-Containing Wastes Generated During Treatment of Sulfide Ores

(75) Inventor: Jay Charles Smith, Pearl River, LA (US)

(73) Assignee: Altynalmas Gold Ltd., a Canada Corporation, Vancouver (CA)

(21) Appl. No.: 13/075,291

(22) Filed: Mar. 30, 2011

Related U.S. Application Data
(60) Provisional application No. 61/460,138, filed on Dec. 27, 2010.

(51) Int. Cl. C01G 28/02

(52) U.S. Cl. 423/87

(57) ABSTRACT

A method is provided for the efficient stabilization, removal and disposal of arsenic-containing wastes generated in metal recovery processes that employ roasting techniques and the like. The conversion of the mostly trivalent arsenite compounds in the wastes to mostly pentavalent solid arsenate precipitates is accomplished by mixing the wastes with water and a ground iron-containing mineral, such as goethite, to form an aqueous slurry of wastes and ground iron-containing mineral, acidifying the slurry to a pH of less than about 1.0, treating the acidified slurry with oxygen gas in a pressurized vessel at a temperature higher than about 120° C. and providing an oxidation catalyst comprised of a water-soluble nitrate and a water-soluble iodide. The overall efficiency of the controlling chemical reactions is improved by the addition and use of the catalyst. The resulting solid arsenate precipitates, in the form of scorodite, are ideally suited for safe disposal with minimum or no further treatment. Unconverted soluble trivalent arsenic compounds remaining in solution may be converted and precipitated as additional scorodite by mixing and agitating the slurry with soluble iron salts under controlled conditions. The resulting precipitates meet or exceed environmental requirements for impoundment and safe disposal.

This application is a non-provisional application for patent entitled to a filing date and claiming the benefit of earlier-filed Provisional Application for Patent No. 61/460,138, filed on Dec. 27, 2010 under 37 CFR 1.53 (c).

### FIELD OF THE INVENTION

This invention relates to the pressure oxidation of arsenic-containing wastes for the purpose of stabilizing and disposing of them. In general, the invention relates to the treatment of arsenic-containing wastes that are generated in chemical and metallurgical processes where arsenic-containing sulfide ores are roasted or smelted and further processed in order to recover one or more valuable metals such as gold, copper, nickel, cobalt, molybdenum and the like. In one specific embodiment this invention relates to a method of catalyzing and improving the pressure oxidation of arsenic trioxide compounds found in off-gases generated during the roasting of gold-and-arsenic containing ores. The invention is also concerned with the catalyzed chemical reaction of trivalent arsenic impurities with gaseous oxygen and iron-containing minerals in order to convert such trivalent arsenic impurities to substantially insoluble and stabilized pentavalent arsenates, which then may be safely removed and impounded or otherwise disposed of with minimal environmental consequences.

### BACKGROUND OF THE INVENTION

Arsenic trioxide compounds, sometimes referred to as “arsenic impurities”, are generated during the treatment of gold-and/or-other-metal-containing sulfidic ores by means of certain roasting and smelting techniques. Roasting and smelting operations usually generate a roasted sulfidic ore or another intermediate product, e.g., a matte, which is further processed to recover the gold and/or other metals by conventional techniques such as cyanide extraction and the like. These operations also generate off-gases that contain various compounds, including arsenic impurities. In the case of gold ore roasting, arsenic compounds tend to interfere with cyanide extraction and other techniques used to recover the gold from the roasted ore, so conditions in the roaster are often controlled to cause most of the formed arsenic compounds to report in the off-gases rather than with the roasted ore. In a typical reductive roasting of gold-containing arsenopyrite and pyrite ores, for example, the generated off-gases contain compounds such as oxygen, nitrogen, carbon monoxide, carbon dioxide and sulfur dioxide, in addition to arsenic impurities. These gases are usually cooled and cleaned to remove arsenic impurities and other environmentally objectionable compounds. The arsenic impurities, usually present as arsenic trioxide, may be removed with bag filters or electrostatic precipitators as dry solids, or they may be removed by means of wet scrubbers in slurry or solution form. These impurities, containing mostly trivalent arsenic compounds, are often disposed of as such in special facilities for such disposal.

Pentavalent arsenic, in the form of arsenate, particularly ferric arsenate, is, however, recognized to be less soluble than trivalent arsenic and better suited for disposal or impoundment with minimum risk to the environment. The chemical conversion of trivalent arsenic compounds to ferric arsenate has been the object of some research; but the high cost of the reagents needed for the conversion has been a deterrent to its commercial implementation. See, for example, U.S. Pat. No. 4,647,307, of Raudsepp et al., U.S. Pat. No. 4,769,230, of Greco et al., U.S. Pat. No. 4,891,207, of Broome, and U.S. Pat. No. 5,026,530, of Drinkard et al. The present invention provides a commercially effective and efficient method of converting trivalent arsenic compounds to arsenates by means of oxygen gas, which makes use of relatively inexpensive reagents to accomplish the conversion. The equipment and the conditions provided by the method of the invention for this oxidation are well suited for the simultaneous solubilization of iron from naturally-occurring iron-bearing minerals, such as goethite and limonite, and the precipitation of a chemically stable hydrated ferric arsenate, i.e., scorodite, that is ideally suited to be safely impounded or otherwise disposed of with minimal or no health hazard.

Examples of ore roasting processes that have been used for extracting gold and/or other metals are described in U.S. Pat. Nos. 2,696,280, 2,650,159, 2,867,529, 3,150,960, 4,731,114, 4,919,715, 5,074,909, 5,123,956 and 5,762,891. Most of these patents mention and/or address the generation of arsenic compounds as part of the roasting operation. None of them, however, describes or suggests the catalyzed reactions using the reactants and the catalysts and conditions provided by the method of this invention.

Halides, such as iodides, have been advocated before to catalyze certain oxidation reactions in other systems. See, for example, U.S. Pat. No. 4,769,230, of Greco et al., where halides are used to catalyze the conversion of arsenous acid to arsenic acid. Greco et al., however, do not simultaneously dissolve iron in the liquid phase of the reaction mass, make use of goethite or other naturally-occurring hydrated iron oxides, or cause the formation of easy-to-handle-and-remove scorodite precipitates.

It is an object of this invention to provide a method for the effective treatment and stabilization of arsenic-containing wastes generated during the roasting or smelting of sulfide ores that does not suffer from the shortcomings of other prior methods. It is another object of this invention to provide a method for treating and removing arsenic compounds found in off-gases generated during the roasting or smelting of gold-and-arsenic-containing sulfidic ores. A further object of the invention is to provide a catalyst, a type of reactant and the operating conditions required to effectively cause, accelerate and improve the overall efficiency of the pressure oxidation of arsenic trioxide impurities. Another object of the invention is to provide a practical and efficient method for treating and removing arsenic impurities from sulfide ore roasting processes in a form that allows such impurities to be safely impounded or otherwise disposed of with minimal or no environmental consequences. Yet another object of the invention is to provide a practical and efficient method for treating and removing such arsenic impurities from gold roasting processes in the form of precipitated scorodite, which form allows such impurities to be safely impounded or otherwise disposed of with minimal or no environmental consequences. These and other objects of the invention will become apparent from the descriptions that follow.

### SUMMARY OF THE INVENTION

The invention centers around the novel use of certain reactants and certain catalysts under controlled conditions in the process chemical reactions of soluble trivalent arsenic compounds with oxygen under pressure in order to convert and precipitate the arsenic compounds as pentavalent arsenate compounds, which then may be safely removed from the process and properly disposed of.

The method of the invention comprises mixing the wastes that contain these soluble trivalent arsenic compounds with water and a ground iron-containing mineral such as goethite, limonite, siderite and mixtures thereof to form an aqueous slurry of these wastes and ground iron-containing mineral, acidifying the slurry to a pH of less than about 1.0, treating the acidified slurry with oxygen gas in a pressurized vessel at a temperature higher than about 120° C. and simultaneously providing an oxidation catalyst comprised of a water-soluble iodide and a water-soluble nitrate. This combination of reactants, catalyst and conditions cause simultaneous chemical reactions among the trivalent arsenic compounds, the oxygen gas and the ground iron-containing mineral which are then allowed to proceed until most of the trivalent arsenic compounds are converted to and precipitated as crystalline FeAsO₄.2H₂O. Thereafter, the treated slurry containing crystalline FeAsO₄.2H₂O is removed from the pressurized vessel and may be safely disposed of.

One embodiment of the method of the invention uses a combination of HNO₃ (nitric acid) and KI (potassium iodide) to effectively catalyze the pressure oxidation of trivalent arsenic impurities in the presence of the ground iron-containing mineral using gaseous O₂ as the oxidant. This combination of HNO₃ and KI as the catalyst is one of the key features of this embodiment. In another embodiment other combinations of nitrates and iodides are used as the catalysts for the oxidation reaction. As referred to in this specification, nitrates include HNO₃ (nitric acid), NaNO₃ (sodium nitrate), NH₄NO₃ (ammonium nitrate) and any other water-soluble nitrate. Iodides include KI (potassium iodide), NaI (sodium iodide) and any other water-soluble iodide. A preferred embodiment of the invention utilizes a mixture of nitric acid and potassium iodide in solution as the catalyst in a pressurized vessel at a temperature higher than about 120° C. and adds goethite (FeO (OH)) to the reactants while acidifying the resulting slurry to a pH of less than about 1.0 to cause the formation of scorodite (FeAsO₄.2H₂O), a stable iron arsenate precipitate that is quite suitable for safe removal and disposal. Siderite (FeCO₃) and limonite (a mixture of hydrated iron oxides, mostly goethite with lepidocrocite, jarosite and others) may be used in addition to or instead of goethite.

The chemical reactions of the method of the invention are always carried out under pressure to insure that certain optimal temperatures are reached during the critical time that the reactants are in contact with each other. A number of pressurized vessels may be used for this purpose. A conventional autoclave, adapted to the particular requirements of the slurry being treated, is usually preferred. The temperature in the autoclave should be maintained between about 150° C. and about 200° C., and preferably between about 165° C. and about 180° C. The pressure inside the autoclave should be maintained between about 150 psia and 400 psia, and preferably between about 200 psia and 300 psia.

The catalyst of the method of this invention is best supplied in the form of an aqueous solution containing the required amounts of water-soluble nitrates and water-soluble iodides. Preferably, the aqueous solution should have a minimum concentration of water-soluble nitrates of approximately 5 grams of nitrates per liter of aqueous solution, and a minimum concentration of water-soluble iodides of approximately 0.2 grams of iodides per liter of aqueous solution. As used in this specification in connection with the composition of the catalyst, all nitrate amounts are expressed in terms of HNO₃, and all iodide amounts are expressed in term of KI.

### BRIEF DESCRIPTION OF THE DRAWING

FIG. 1 is a schematic diagram depicting the unit operations of a sulfide ore gold recovery process that uses reductive roasting and generates off-gases containing arsenic impurities, and showing the processing of the off-gases and the treatment of the arsenic-containing wastes in a pressurized autoclave using the method of this invention.

### DETAILED DESCRIPTION OF THE INVENTION

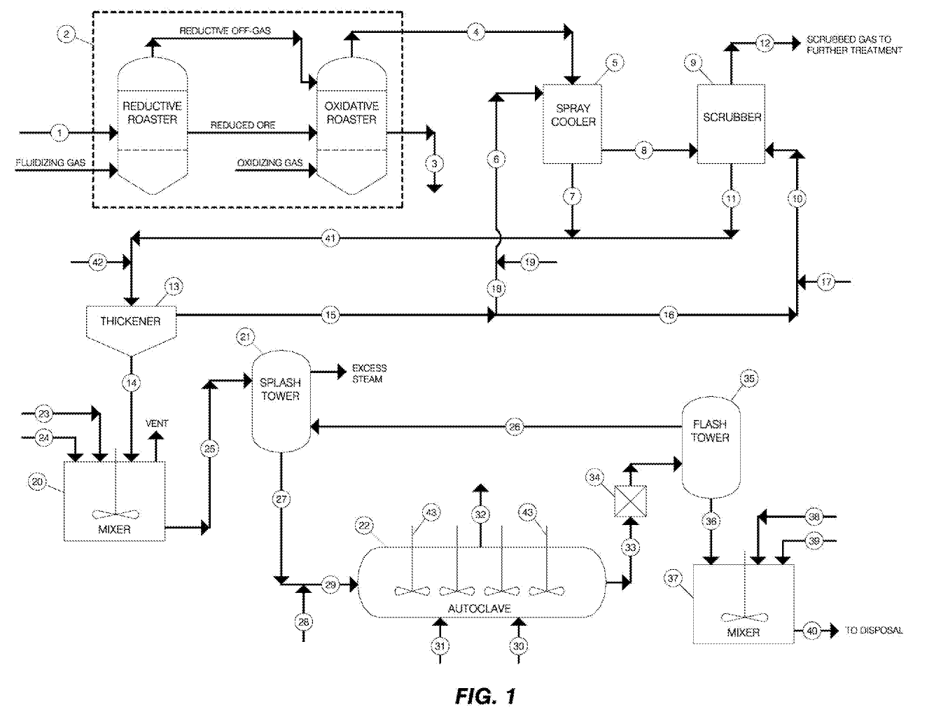

By way of an illustration, the method of the invention may be described with reference to the handling and treatment of arsenic-containing wastes such as those generated in a metallurgical process for recovering gold from gold-bearing sulfide ores by means of roasting. An example of one such process is depicted in schematic form in FIG. 1, where a gold-bearing arsenopyrite ore is shown undergoing reductive roasting in a roasting operation of the type that generates off-gases containing the arsenic impurities as well as other compounds. The basic unit operations of the processing of the off-gases and the handling and treatment of the generated arsenic-containing wastes using the method of the invention are also shown in FIG. 1.

Thus, referring to FIG. 1, ground gold-bearing arsenopyrite ore 1 is fed to roasting operations 2, where it is first roasted in the absence, or with substoichiometric amounts, of oxygen and then with greater than stoichiometric amounts of oxygen at temperatures exceeding 500° C. to produce a gold-containing roasted ore 3 that is suitable for further treatment such as, for example, cyanide leaching extraction, in order to recover the gold from it. Roasting operations 2 may include a first-stage reductive roasting with a fluidizing gas such as air, for example, and a second-stage oxidative roasting with an oxidizing gas, which may also be air. In such an arrangement the off-gases from the reductive roaster may be used to provide a portion of the heat needed in the oxidative roaster. Other such similar arrangements of roasting or smelting unit operations may also be used, including some where the roaster, or roasters, are operated only in an oxidative mode. In the roasters, solid arsenopyrite compounds such as, for example, FeAsS are converted to gaseous arsenic impurities such as, for example, As₂O₃. These arsenic impurities exit the roasters with generated off-gases 4, which are laden with other gaseous compounds such as oxygen, nitrogen, carbon monoxide, carbon dioxide and sulfur dioxide. Off-gases 4 are usually processed by sending them to be cooled in conventional cooling vessels such as, for example, cooling spray tower 5. Cooling water 6 and spent cooling water 7 enter and exit direct-contact cooling spray tower 5, respectively. The cooled gases 8 are fed to one or more conventional dust scrubber 9, where they contact incoming scrub water 10. Most of the arsenic impurities are then dissolved and separated as scrubber underflow slurry 11. Spent cooling water 7 also contains some of the arsenic impurities. Scrubbed gases 12 are normally sent to further treatment (not shown) such as, for example, wet electrostatic precipitation to remove mist and particular matter, followed by further scrubbing to remove SO₂; then to one or more bag filters to remove more particulates, then to CO incineration and finally to NOₓ reduction before being vented.

Scrubber underflow slurry 11, containing most of the arsenic impurities, is subsequently combined with arsenic-containing spent cooling water 7 from spray cooler 5 and the resulting slurry stream 41 is then fed to thickener 13, where it is thickened and separated into two streams: thickener underflow 14 and thickener overflow 15. A flocculant 42 may be added directly into slurry stream 41 (as shown) or into thickener 13 to aid in the thickening operation. A first portion 16 of thickener overflow 15 may be conveniently combined with make-up scrub water 17 to become scrub water 10, which is fed to dust scrubber 9; while a second portion 18 of thickener overflow 15 may be conveniently combined with make-up cooling water 19 to become cooling water 6, fed to cooling spray tower 5. Thickener underflow 14 is an aqueous slurry of precipitated and dissolved arsenic impurities and dust from the roaster and other upstream unit operations. This slurry of arsenic-containing wastes may be fed into mixing tank 20 to first be mixed with a mixture of ground goethite slurry 23 and an aqueous solution of sulfuric acid 24 and then go into splash tower 21 to be contacted (pre-heated) with steam before being fed to the autoclave 22, as shown in FIG. 1, or it may be fed directly into the autoclave (not shown). Preferably, this slurry of arsenic-containing wastes, i.e., thickener underflow 14, is first mixed with ground goethite slurry 23 and solution of sulfuric acid 24, and the resulting slurry mixture 25 sent to splash tower 21. Steam 26 is used to pre-heat slurry mixture 25 in splash tower 21. Splash tower underflow 27 is a pre-heated aqueous slurry containing precipitated and dissolved arsenic impurities and dust, as well as the mixture of ground goethite and sulfuric acid. Special catalyst 28, in the form of an aqueous solution of water-soluble nitrates and water-soluble iodides, is then injected into splash tower underflow 27, which then becomes autoclave feed 29. The amounts of water-soluble nitrates and water-soluble iodides in catalyst 28 added to splash tower underflow 27 are monitored and adjusted so as to provide approximately 5 grams of nitrate, expressed as HNO₃, per liter of aqueous phase of autoclave feed slurry 29 and approximately 0.2 grams of iodide, expressed as KI, per liter of aqueous phase of autoclave feed slurry 29. The water-soluble nitrates and water-soluble iodides that comprise catalyst 28 may be fed into splash tower underflow 27 as one stream, as shown in FIG. 1, or they may be fed as two separate streams.

Conditions in autoclave 22 are adjusted to provide an operating temperature of about 165° C. and an operating pressure of about 300 psia to cause and maximize the efficiency of the chemical reactions during the critical time that the reactants are in contact with each other. Depending on parameters such as feed volume, retention time and concentration of arsenic impurities in the autoclave feed, the temperature inside autoclave 22 may be controlled between about 150° C. and about 200° C., and preferably between about 165° C. and about 180° C. Likewise, the pressure inside autoclave 22 may be set between about 150 psia and 400 psia, and preferably between about 200 psia and 300 psia. Steam 30 is used to provide heat to the reactants inside autoclave 22 and maintain the reaction mixture at the desired temperature. Oxygen gas 31 is injected into the autoclave to create an oxygen overpressure of approximately 100 psi. Provisions are made to vent the system as needed, for example, by venting gas 32, and for mixing the contents of autoclave 22, for example by means of mechanical mixers 43. Oxygen gas 31 should be provided in amounts sufficient to create an oxygen overpressure of between about 75 psi and 200 psi.

Exiting autoclave 22, autoclave effluent slurry 33 flows through pressure chocker valve 34 and into flash tower 35, from where it is directed, as partially-precipitated autoclave effluent slurry 36, into mixing tank 37 to undergo a secondary treatment. In mixing tank 37 partially-precipitated autoclave effluent slurry 36, now containing the bulk (90% or higher and, preferably, 95% or higher) of the arsenic impurities fed into the autoclave as precipitated arsenates, is mixed and agitated with soluble iron salts 38, such as ferric sulfate or ferrous sulfate, to further advance the degree of completion of the precipitation and achieve complete precipitation (99% or higher) of the incoming arsenic impurities as arsenates. Lime 39, preferably in slurry form, is also added into mixing tank 37 in order to adjust the pH of the reactants in the mixing tank to between about 1.5 and 5.0. These arsenates, in the form of precipitated and stable scorodite 40, are then removed from the process and sent to be properly impounded or otherwise disposed of with minimal or no environmental consequences.

The basic chemical reaction of the pressure oxidation of the arsenite impurities may be depicted by the chemical equation:

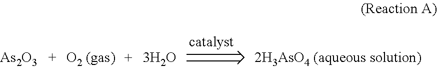

In one preferred embodiment contemplated by the method of the invention goethite, i.e., FeO (OH), is the ground iron-containing mineral that is added to the reactants and to the catalyst, and the resulting reaction may be depicted by the chemical equation:

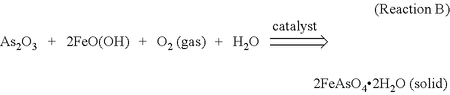

The addition of goethite in Reaction B results in the formation of scorodite, i.e., FeAsO₄.2H₂O, a hydrated arsenate compound that is precipitated in solid form and may then be separated and disposed of with minimal further treatment and handling.

When the slurry containing the iron-bearing mineral (in this case goethite) is heated in the autoclave, iron dissolves from the mineral and then reacts with arsenate, formed by oxidation of arsenite, to precipitate the scorodite (FeAsO₄.2H₂O). Acidity (pH about 1.0 or less) aids in dissolving the iron that is needed for scorodite formation, for example, by the reaction:

FeO(OH)+3H⁺→Fe⁺³+2H₂O

It has been found that the addition of relatively small amounts of an acid, in excess of that provided by HNO₃ when it is used as a catalyst, is useful for enhancing the formation of scorodite. Sulfuric acid is the preferred acid for slurry acidification because of its low cost, but other acids may also be used.

It is surmised that the solubilized iron, in its trivalent state, is then able to react with the arsenic and form the scorodite (FeAsO₄.2H₂O), for example, by the reactions:

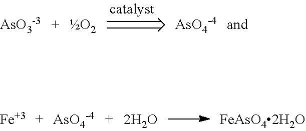

In addition to, or instead of, goethite other ground iron-containing minerals such as, for example, limonite or siderite may be used which also cause the formation of stable scorodite precipitates. If siderite is used, more acid may be needed in order to decompose the carbonate in that mineral, and the iron must be oxidized from its ferrous state (Fe⁺²) to its ferric state (Fe⁺³). Conditions that are effective in oxidizing trivalent arsenic (As⁺³) are also effective in oxidizing iron from its ferrous state to its ferric state.

In formulating the mixture of water-soluble nitrates and water-soluble iodides that make up the catalyst solution of the invention, the preferred minimum concentration of nitrates is 5 grams of HNO₃ per liter of aqueous solution; and the preferred minimum concentration of iodides is 0.2 grams of KI per liter of aqueous solution. Other ranges of nitrates and iodides may be used as shown by the results obtained from the tests described below.

The applicability and efficiency of the reactants, catalyst and required conditions of the method of the invention were confirmed in several tests conducted for that purpose. Bench-scale equipment was used in these tests. Thus a half-liter bench-scale-size autoclave was fitted with the necessary hardware; and a mixture of reagent-grade As₂O₃ powder and dust generated in a pilot roaster from a gold ore reductive roasting operation was slurried with water and fed to the autoclave along with ground natural goethite ore. The As₂O₃ powder, dust, water and goethite were added in monitored amounts so that the feed to the autoclave was a slurry of about 30% solids and about 70% liquid. Except as otherwise indicated in Table I and Table II below, the autoclave was operated under a pressure of about 200 psia and at a temperature of 165° C.

For all autoclave runs, all reagents were sealed in the autoclave and then the autoclave was placed in a heating mantle. After oxygen purging and setting the autoclave pressure to provide the indicated oxygen overpressure, the mantle was turned on and brought to the desired operating temperature. This heat up usually took about 15 minutes. The mantle was controlled with a rheostat, and settings were recorded during each experiment. At the end of the experiments, the autoclave was removed from the mantle and cooled in a water bath and vented once below 100° C. Unless otherwise indicated in Table I and Table II below, the retention time used in the tests was 180 minutes. Also added to the autoclave in these tests was sulfuric acid in amounts sufficient to lower the pH of the liquid phase of the slurry and provide and acidity level in the liquid phase between about 20 and about 50 gpl, expressed in terms of H₂SO₄, depending on the particular test. The acidity level and the pH of the liquid phase in each case are also shown in Table I and Table II below. Except as otherwise noted (e.g., in Test No. 47), enough oxygen gas was injected into the autoclave to create an oxygen overpressure of 100 psi in each test. In each test the reactants were then allowed to react with each other under these conditions, and the results of the presence or absence of the catalysts were measured and recorded. Thus in each case the amount of trivalent arsenic, as As, left in solution at the end of the test was measured and reported in grams per liter (see As⁺³, under Final Solution Assays); the amount of total arsenic, as As, left in solution at the end of the test was also measured and reported in grams per liter (see As Total, under Final Solution Assays); the amount of iron, as Fe, left in solution at the end of the test was measured and reported in grams per liter (see Fe Total, under Final Solution Assays); and the total amount of arsenic, as As, left in solution as a percentage of the total amount of arsenic, as As, fed to the autoclave was also measured, calculated and reported (see As Left in Solution). The oxidation reduction potential (ORP) was measured on filtered solution at room temperature using ORP electrodes (Pt—Ag/AgCl in 3 M KCl); and the direct meter readings, in millivolts, are reported in Table I and Table II (see EMF). Add 211 millivolts at 20° C. to convert the direct meter readings to Eh.

Some of the tests listed on Table I and Table II were carried out without any catalysts at all; some were carried out with the help of one of the catalysts of the invention, varying the relative amounts of water-soluble nitrates and water-soluble iodides in the catalysts used in the tests; while others involved the use of “test catalysts” containing nitrates but no iodides and “test catalysts” containing iodides but no nitrates. The tests that were conducted with the help of one of the catalysts of the invention used a mixture of HNO₃ and KI, in various proportions, as the solute of the solution catalyst. A high number such as 20 g/l, or higher, for the amount of trivalent arsenic, as As, left in solution at the end of a test (As⁺³, under Final Solution Assays) indicates an unsatisfactory degree of oxidation of the arsenic; while a low number such as 2, or lower, indicates a very good degree of oxidation of the arsenic. Anything in between is considered average or mediocre. A high number such as 40%, or higher, for the total amount of arsenic, as As, left in solution as a percentage of the total amount of arsenic, as As, fed to the autoclave (As Left in Solution) is interpreted as a failure to sufficiently precipitate the arsenic; while a low number such as 10%, or lower, indicates success in precipitating the arsenic. Anything in between is considered average or mediocre. Numbers lower than about 5% of As Left in Solution equate to excellent results in arsenic precipitation and high degree of success in accomplishing the intended purpose of the method of the invention, i.e., the safe precipitation of substantially all of the arsenic in the incoming wastes in the form of scordite suitable for removal and subsequent disposal with minimal environmental consequences.

The results shown on Table I and Table II illustrate the effect of the use, or non-use, of the catalysts, reactants and operating conditions of the invention on the precipitation of the arsenic impurities and the eventual formation, or non-formation, of scorodite solids. As shown on Table I and Table II, a high degree of oxidation of the arsenic is required, but does not necessarily translate into good results in arsenic precipitation and success in accomplishing the intended purpose of the method of the invention. For example, Tests No. 5, 7 and 9 on Table I resulted in excellent arsenic oxidation numbers, as measured by the amount of trivalent arsenic, as As, left in solution at the end of each test (As⁺³, under Final Solution Assays), of 0.05 g/l, 0.13 g/p and 0.64 g/p, respectively; yet the actual arsenic precipitation, as shown by the 57%, 53% and 98% of As Left in Solution, respectively, was rather poor in each of them. The stipulated nitrate-and-iodide solution catalyst of the method of the invention was not used in Tests No. 5, 7 or 9, as indicated on Table 1. On the other hand, excellent results (2.1%, 0.3%, 4.0% and 0.6% of As Left in Solution, respectively) were obtained in Tests No. 15, 21, 22 and 23, also listed on Table 1, when the stipulated nitrate-and-iodide solution catalyst of the method of the invention was used in conjunction with the stipulated use of goethite and other conditions of the method of the invention. Tests No. 31, 34 and 51, on Table II, also confirm the excellent results (2.8%, 0.9% and 2.4% of As Left in Solution, respectively) obtainable from combining the use of goethite and the stipulated nitrate-and-iodide solution catalyst with the other conditions of the method of the invention. Unsuccessful Tests No. 56 and 57, on Table II, resulting in poor arsenic precipitation, as shown by the 55% and 31% of As Left in Solution, respectively, are very similar to successful Tests No. 31, 34 and 51, as shown by 2.8%, 0.9% and 2.4% of As Left in Solution, respectively, except that hematite was used as the iron source in unsuccessful Tests No. 56 and 57, whereas goethite was used as the iron source in successful Tests No. 34 and 51. Certain other tests on Table I and Table II tend to show the inability to obtain good results when the required reagents, catalysts and conditions of the method of the invention are not fully used or implemented.

Table III specifically illustrates the stability of the final product made by the secondary treatment embodiment of the method of the invention and its suitability for disposal in accordance a procedure that mimics the U.S. Environmental Protection Agency's Toxic Characteristics Leaching Procedures (“TCLP”)

The invention is able to achieve these results using reactants like goethite, nitrates and oxygen that are relatively inexpensive and allow for low operating costs.

TABLE I
Exploratory Tests Pertaining to Pressure Oxidation of As(III)
to As(V) with Simultaneous Precipitation of Scorodite

| | | | | | | Note 1 | | | |
|---|---|---|---|---|---|---|---|---|---|
| | Record | | O₂ Over | Run | As in | Slurry | Acidity | | Fe/As |
| Test | Book and | Temp. | Pressure | Time | Feed | Solids | H₂SO₄ | Iron | Mole |
| No. | Page | C. | psi | min | g | % | gpl | Source | Ratio |
| 1 | 3294-12 | 150 | 100 | 30 | 1.1 | 5.2 | 0.0 | None | 0.00 |
| 2 | 3294-14 | 150 | 100 | 60 | 0.9 | 4.6 | 0.0 | None | 0.00 |
| 3 | 3294-16 | 150 | 100 | 60 | 1.9 | 17.1 | 0.0 | Hematite | 10.73 |
| 4 | 3294-18 | 150 | 100 | 60 | 1.9 | 17.8 | 0.0 | Goethite | 7.92 |
| 5 | 3294-21 | 150 | 100 | 60 | 7.6 | 5.3 | 1.0 | Goethite | 0.10 |
| 6 | 3294-30 | 150 | 100 | 120 | 1.9 | 10.0 | 0.0 | Goethite | 0.81 |
| 7 | 3294-34 | 150 | 100 | 180 | 1.9 | 10.6 | 28.8 | Goethite | 1.22 |
| 8 | 3175-114 | 150 | 100 | 180 | 1.9 | 10.6 | 28.9 | Goethite | 1.22 |
| 9 | 3175-118 | 150 | 100 | 180 | 1.9 | 9.1 | 28.8 | None | 0.00 |
| 10 | 3175-123 | 150 | 100 | 180 | 10.3 | 30.6 | 28.9 | Goethite | 1.21 |
| 11 | 3175-128 | 150 | 100 | 180 | 10.3 | 30.1 | 47.4 | Goethite | 1.21 |
| 12 | 3175-132 | 150 | 100 | 180 | 10.6 | 30.0 | 39.8 | Goethite | 1.42 |
| 13 | 3175-135 | 150 | 100 | 180 | 10.5 | 30.3 | 25.0 | Goethite | 1.44 |
| 14 | 3175-143 | 150 | 100 | 180 | 10.3 | 30.5 | 28.8 | Goethite | 1.21 |
| 15 | 3175-146 | 165 | 100 | 180 | 12.0 | 30.6 | 28.7 | Goethite | 1.11 |
| 16 | 3175-151 | 165 | 100 | 90 | 12.0 | 30.6 | 29.0 | Goethite | 1.11 |
| 17 | 3312-12 | 200 | 100 | 60 | 12.2 | 30.2 | 28.8 | Goethite | 1.00 |
| 18 | 3312-15 | 165 | 100 | 180 | 12.0 | 30.6 | 28.8 | Goethite | 1.11 |
| 19 | 3312-19 | 200 | 100 | 180 | 12.0 | 30.2 | 29.3 | Goethite | 1.11 |
| 20 | 3312-23 | 165 | 100 | 180 | 12.0 | 31.3 | 28.8 | Goethite | 1.23 |
| 21 | 3312-31 | 165 | 100 | 180 | 12.1 | 30.6 | 27.7 | Goethite | 1.10 |
| 22 | 3312-36 | 165 | 100 | 180 | 95.0 | 31.4 | 29.4 | Goethite | 1.10 |
| 23 | 3294-103 | 165 | 100 | 180 | 12.0 | 31.0 | 28.8 | Goethite | 1.12 |
| 24 | 3294-107 | 165 | 100 | 180 | 12.0 | 31.0 | 28.7 | Goethite | 1.12 |
| 25 | 3294-111 | 165 | 100 | 180 | 12.0 | 31.0 | 28.8 | Goethite | 1.12 |
| 26 | 3294-117 | 165 | 100 | 180 | 12.0 | 31.0 | 28.7 | Goethite | 1.12 |

| | | | | | Final Solution Assays | | | | |
|---|---|---|---|---|---|---|---|---|---|
| | Catalysts | | | | | As | Fe | As Left in | |
| Test | HNO₃ | KI | Note 2 | Note 3 | As³⁺ | Total | Total | Solution | Other |
| No. | gpl | gpl | pH | EMF | g/L | g/L | g/L | % of Feed | Note |
| 1 | 7 | 0 | 1.00 | | | 3.69 | | 96 | |
| 2 | 7 | 0 | 2.00 | | | 2.45 | | 94 | |
| 3 | 0 | 0 | 6.00 | | 5.94 | 5.94 | 0.004 | 92 | |
| 4 | 0 | 0 | 6.00 | | 5.01 | 5.01 | 0.004 | 76 | |
| 5 | 0 | 0 | 1.30 | 645 | 0.05 | 1.2 | 0.004 | 57 | |
| 6 | 5 | 0 | 1.50 | 474 | 8.18 | 8.18 | 0.016 | 93 | |
| 7 | 5 | 0 | 0.48 | 566 | 0.13 | 5.39 | 0.095 | 53 | |
| 8 | 0 | 0 | 0.68 | 512 | 8.35 | 8.35 | 1.940 | 97 | |
| 9 | 5 | 0 | 0.54 | 542 | 0.64 | 10.9 | 0.290 | 98 | |
| 10 | 5 | 0 | 0.60 | 544 | 14.1 | 14.1 | 0.340 | 24 | |
| 11 | 5 | 0 | 0.46 | 433 | 14.9 | 14.9 | 5.290 | 18 | |
| 12 | 5 | 0 | 0.57 | 554 | 16.3 | 16.3 | 0.160 | 23 | |
| 13 | 5 | 0 | 0.87 | 506 | 13.5 | 13.5 | 0.500 | 30 | |
| 14 | 5 | 0.2 | 0.91 | 375 | 9.4 | 9.39 | 2.000 | 7.6 | |
| 15 | 5 | 0.2 | 0.40 | 534 | 0.01 | 3.64 | 0.055 | 2.1 | |
| 16 | 5 | 0.2 | 0.35 | 389 | 9.94 | 26.5 | 0.042 | 19 | |
| 17 | 5 | 0 | 0.53 | 409 | 22.6 | 23.7 | 1.760 | 20 | |
| 18 | 5 | 0.2 | 0.49 | 530 | 0.055 | 0.374 | 0.210 | 0.3 | |
| 19 | 5 | 0 | 0.74 | 531 | 0.04 | 0.68 | 0.091 | 0.5 | |
| 20 | 5 | 0.2 | 0.87 | 508 | 0.04 | 1.06 | 0.136 | 0.8 | |
| 21 | 5 | 0.2 | 0.93 | 505 | 0.03 | 0.30 | 0.143 | 0.3 | 4 |
| 22 | 5 | 0.2 | 0.69 | 532 | 0.03 | 3.89 | 0.040 | 4.0 | 5 |
| 23 | 5 | 0.2 | 1.56 | 527 | 0.13 | 0.53 | 0.075 | 0.6 | 6 |
| 24 | 5 | 0.2 | 0.85 | 490 | 0.14 | 3.42 | 0.046 | 4.5 | 7 |
| 25 | 5 | 0.2 | 0.80 | 551 | 0.07 | 4.18 | 0.017 | 5.2 | 7 |
| 26 | 5 | 0.2 | 1.50 | 507 | 0.14 | 3.42 | 0.021 | 5.2 | 7 |

Notes:
1. Mass of primary solid-phase feed materials (roaster dust, supplemental As2O3 and iron feed component) divided by total entering mass.
2. Determined after cooling to ambient temperature (20-30° C.).
3. Direct oxidation-reduction potential reading in millivolts (not adjusted) using Pt—Ag/AgCl electrode in 3 molar KCl. Determined from filtrate at ambient temperature (20-30° C.).
4. Duplicated conditions of Test 15 to produce material for cyanide leach
5. Duplicated conditions of Test 15 but at larger scale in 2 L autoclave to produce material for cyanide leach
6. Duplicated conditions of Test 15 but add about 3 gpl SO₂ to starting solution
7. Duplicated conditions of Test 23 to produce material for secondary treatment test

TABLE II
Investigation of Conditions Pertaining to Pressure Oxidation of
As(III) with Simultaneous Precipitation of Arsenic as Scorodite

| | | | | | | Note 1 | | | | |
|---|---|---|---|---|---|---|---|---|---|---|
| | Record | | O₂ Over | Run | As in | Slurry | Acidity | | Fe/As | Catalysts |
| Test | Book and | Temp. | Pressure | Time | Feed | Solids | H₂SO₄ | Iron | Mole | HNO₃ |
| No. | Page | C. | psi | min | g | % | gpl | Source | Ratio | gpl |
| 27 | 3294-123 | 165 | 100 | 180 | 12.0 | 31.0 | 35 | Goethite | 1.12 | 0 |
| 28 | 3294-125 | 165 | 100 | 180 | 12.0 | 31.0 | 30 | Goethite | 1.12 | 5 |
| 29 | 3294-127 | 165 | 100 | 180 | 12.0 | 31.0 | 35 | Goethite | 1.12 | 0 |
| 30 | 3294-129 | 165 | 100 | 180 | 12.0 | 31.2 | 20 | Goethite | 1.12 | 5 |
| 31 | 3294-131 | 165 | 100 | 180 | 12.0 | 30.8 | 40 | Goethite | 1.12 | 5 |
| 32 | 3294-133 | 165 | 100 | 180 | 12.0 | 30.8 | 35 | Goethite | 1.12 | 0 |
| 33 | 3294-135 | 165 | 100 | 180 | 12.0 | 31.7 | 35 | Goethite | 1.12 | 0 |
| 34 | 3294-137 | 165 | 100 | 180 | 12.0 | 38.9 | 40 | Goethite | 2.60 | 5 |
| 35 | 3294-139 | 165 | 100 | 180 | 12.0 | 38.8 | 40 | Goethite | 2.61 | 7.5 |
| 36 | 3294-141 | 165 | 100 | 180 | 12.0 | 39.0 | 40 | Goethite | 2.60 | 0 |
| 37 | 3294-145 | 165 | 100 | 180 | 12.0 | 32.0 | 40 | Goethite | 1.33 | 5 |
| 38 | 3294-147 | 165 | 100 | 180 | 12.0 | 32.0 | 40 | Goethite | 1.32 | 5 |
| 39 | 3294-149 | 165 | 100 | 180 | 12.0 | 31.9 | 40 | Goethite | 1.32 | 10 |
| 40 | 3294-151 | 165 | 100 | 180 | 12.0 | 32.2 | 40 | Goethite | 1.32 | 0 |
| 41 | 3294-155 | 165 | 100 | 180 | 12.0 | 32.3 | 20 | Goethite | 1.32 | 10 |
| 42 | 3338-3 | 165 | 100 | 180 | 12.0 | 31.7 | 50 | Goethite | 1.32 | 10 |
| 43 | 3338-5 | 165 | 100 | 180 | 12.0 | 31.9 | 40 | Goethite | 1.32 | 10 |
| 44 | 3338-7 | 165 | 100 | 180 | 12.0 | 31.9 | 40 | Goethite | 1.32 | 10 |
| 45 | 3338-9 | 165 | 100 | 180 | 12.0 | 31.7 | 50 | Goethite | 1.32 | 10 |
| 46 | 3338-11 | 165 | 100 | 180 | 12.0 | 31.7 | 50 | Goethite | 1.32 | 10 |
| 47 | 3338-13 | 165 | 150 | 180 | 12.0 | 31.9 | 40 | Goethite | 1.32 | 10 |
| 48 | 3338-15 | 190 | 100 | 180 | 12.0 | 31.9 | 40 | Goethite | 1.32 | 10 |
| 49 | 3338-17 | 180 | 100 | 60 | 12.0 | 32.0 | 40 | Goethite | 1.32 | 5 |
| 50 | 3338-19 | 180 | 100 | 120 | 12.0 | 32.0 | 40 | Goethite | 1.32 | 5 |
| 51 | 3338-21 | 180 | 100 | 180 | 12.0 | 32.0 | 40 | Goethite | 1.32 | 5 |
| 52 | 3338-23 | 180 | 100 | 120 | 12.0 | 32.2 | 30 | Goethite | 1.32 | 5 |
| 53 | 3338-26 | 180 | 100 | 120 | 12.0 | 32.0 | 40 | Goethite | 1.32 | 5 |
| 54 | 3338-29 | 180 | 100 | 120 | 10.7 | 31.9 | 40 | Goethite | 1.58 | 5 |
| 55 | 3338-33 | 180 | 100 | 120 | 10.7 | 31.9 | 40 | Goethite | 1.57 | 5 |
| 56 | 3338-35 | 165 | 100 | 180 | 12.1 | 36.9 | 40 | Hematite | 1.31 | 5 |
| 57 | 3338-37 | 165 | 100 | 180 | 12.1 | 36.9 | 40 | Hematite | 1.31 | 5 |
| 58 | 3338-39 | 165 | 100 | 180 | 12.1 | 22.4 | 40 | None | 0.00 | 5 |
| 59 | 3338-41 | 165 | 100 | 180 | 12.1 | 41.8 | 40 | Fe₂(SO₄)₃ | 1.31 | 5 |

| | | | | | | Final Solution Assays | | | | |
|---|---|---|---|---|---|---|---|---|---|---|
| | Catalysts | | Note 3 | | Note [symbol] | | As | Fe | As Left in | |
| Test | KI | Note 2 | | NO₃⁻ | [symbol] ₜₒₜ | As³⁺ | Total | Total | Solution | Other |
| No. | gpl | pH | EMF | g/L | mg/L | g/L | g/L | g/L | % of Feed | Note |
| 27 | 0 | 0.77 | 419 | | | 25.5 | 25.5 | 0.7960 | 41 | |
| 28 | 0 | 0.74 | 420 | | | 24.4 | 24.4 | 2.55 | 24 | |
| 29 | 0.2 | 0.75 | 391 | | | 19.0 | 19.0 | 1.60 | 28 | |
| 30 | 0.2 | 0.92 | 500 | | | 0.08 | 10.2 | 0.0559 | 8.5 | |
| 31 | 0.2 | 0.80 | 527 | | Low | 0.08 | 2.2 | 0.0839 | 2.8 | 5 |
| 32 | 0 | 0.39 | 437 | | | 18.8 | 18.8 | 0.765 | 25 | 6 |
| 33 | 0 | 0.48 | 430 | | | 16.4 | 16.4 | 1.03 | 35 | |
| 34 | 0.2 | 0.52 | 562 | 2.61 | | 0.19 | 0.89 | 0.35 | 0.9 | |
| 35 | 0 | 0.57 | 431 | | | 16.9 | 16.9 | 3.36 | 32 | |
| 36 | 0.3 | 0.63 | 374 | | | 16.5 | 16.5 | 8.61 | 27 | |
| 37 | 0.1 | 0.75 | 459 | | | 8.69 | 10 | 0.509 | 8.0 | |
| 38 | 0 | 0.72 | 501 | 2.12 | | 15.6 | 15.6 | 0.437 | 27 | 7 |
| 39 | 0 | 0.51 | 641 | 3.01 | | 0.11 | 8.2 | 0.0443 | 6.9 | |
| 40 | 0.4 | 0.48 | 366 | | | 20.1 | 20.1 | 0.44 | 25 | |
| 41 | 0 | 0.84 | 465 | | | 22.1 | 32.6 | 0.46 | 30 | |
| 42 | 0 | 0.50 | 523 | 3.73 | | 16.4 | 20.3 | 1.16 | 19 | |
| 43 | 0 | 0.61 | 482 | 3.81 | | 23.8 | 25.7 | 0.942 | 26 | |
| 44 | 0 | 0.60 | 484 | 6.98 | | 17.8 | 22.2 | 0.717 | 24 | 8 |
| 45 | 0 | 0.50 | 496 | 2.56 | | 14.9 | 30 | 0.351 | 25 | 8 |
| 46 | 0 | 0.42 | 567 | 2.10 | | 10.4 | 24.9 | 0.265 | 21 | 8 |
| 47 | 0 | 0.60 | 570 | 7.44 | | 6.8 | 15.6 | 0.18 | 17 | |
| 48 | 0 | 0.55 | 545 | 4.60 | | 7.48 | 12.63 | 0.195 | 15 | |
| 49 | 0.2 | 0.42 | 398 | 3.01 | | 24.2 | 37.6 | 0.73 | 42 | |
| 50 | 0.2 | 0.61 | 512 | 1.92 | Low | 0.26 | 15.3 | 0.054 | 13 | 9 |
| 51 | 0.2 | 0.67 | 536 | 3.31 | Low | 0.22 | 2.68 | 0.06 | 2.4 | |
| 52 | 0.2 | 0.50 | 536 | 1.60 | 6 | 0.19 | 22.5 | 0.04 | 15 | |
| 53 | 0.2 | 0.45 | NA | | | NA | 2E−04 | NA | <0.001 | 10 |
| 54 | 0.2 | 0.57 | NA | | | NA | 0.085 | NA | 0.5 | 10 |
| 55 | 0.2 | 0.23 | 386 | | | NA | 0.1 | NA | 0.06 | 10 |
| 56 | 0.2 | 0.78 | 366 | | 0 | 43.6 | 30.7 | 1.68 | 55 | |
| 57 | 0.2 | 0.73 | 364 | | 0 | 15.9 | 37.9 | 1.34 | 31 | |
| 58 | 0.2 | 0.44 | 683 | | 20 | 0.38 | 32.4 | 0.0339 | 35 | |
| 59 | 0.2 | −0.30 | 416 | | | 15.7 | 35.4 | 50.1 | 33 | |

Notes:
1. Mass of primary solid-phase feed materials (roaster dust, supplemental As2O3 and iron feed component) divided by total entering mass.
2. Determined after cooling to ambient temperature (20-30° C.).
3. Direct oxidation-reduction potential reading in millivolts (not adjusted) using Pt—Ag/AgCl electrode in 3 molar KCl. Determined from filtrate at ambient temperature (20-30° C.).
4. “Low” indicates qualitative detection but below measurement limit for titrametric procedure.
5. 5 g/l copper added as potential catalyst at the beginning of Test 31.
6. 3 g/l SO2 added at the beginning of Test 32.
7. 5 g/l V added as VOSO₄—4H₂O at the beginning of Test 38
8. Possible signs of autoclave leakage.
9. Ran to produce material for secondary precipitation and TCLP testing.
10. Similar autoclave conditions to Test 50. Following pressure release, autoclave was treated for secondary arsenic precipitation be adding lime to increase pH to 4.5 and adding ferric sulfate to precipitate remaining arsenic. Mixed 30 min and filtered. [symbol]
indicates data missing or illegible when filed

TABLE III
Simulated TCLP Test Results on Stabilized Arsenic-Bearing Flue Dust

| | | | Fe/As | |
|---|---|---|---|---|
| | | Corresponding | Mole Ratio | Arsenic in |
| TCLP | Data Reference | Test in | in Secondary | Leachate |
| Test | notebook-page | Tables I and II | Treatment | mg As/liter |
| A | 3294-115 | 25 | 6:1 | 0.078 |
| B | 3294-121 | 26 | 3:1 | 0.281 |
| C | 3338-30 | 53 | 4:1 | 0.063 |

After treatment by the methods of this invention, samples of arsenic-bearing materials were tested by a modified Toxicity Characteristic Leaching Procedure (TCLP) to determine arsenic mobility. The modified procedure used the reagents and the ratios prescribed by U.S. EPA Test Method 1311-TCLP; but the procedure was modified for smaller sample quantities. EPA Test Method 1311-TCLP is used when evaluating a solid waste for toxicity hazardous waste characteristics. For arsenic, a leachate concentration greater than 5 mg As per liter would indicate a hazardous waste under 40 CFR 261.24 (Title 40 of the Code of Federal Regulations, Part 261.24). Table III shows the results of the modified TCLP procedure for samples containing 10-15% arsenic that had been generated in accordance with the methods of this invention.

While the present invention has been described herein in terms of particular embodiments and applications, in both summarized and detailed forms, it is not intended that any of these descriptions in any way should limit its scope to any such embodiments and applications; and it will be understood that substitutions, changes and variations in the described embodiments, applications and details of the method and the formulations disclosed herein can be made by those skilled in the art without departing from the spirit of this invention. Where the article “a” is used in the following claims, it is intended to mean “at least one” unless clearly indicated otherwise.

1-28. (canceled)

29. A method for treating wastes containing trivalent arsenic oxide compounds that are separated from gases generated in processes in which sulfide ores containing arsenic compounds are roasted or smelted, said method comprising:
(a) mixing said wastes with water and ground goethite to form an aqueous slurry of said wastes and ground goethite, and acidifying said slurry to a pH of between about 0.5 and 1.0;
(b) treating said acidified slurry with oxygen gas in a stirred pressurized vessel at a temperature of between about 150° C. and about 200° C. and a pressure of between about 150 psia and 400 psia while providing an oxidation catalyst comprised of a water-soluble nitrate and a water-soluble iodide and maintaining the pH of said acidified slurry between about 0.5 and 1.0 thereby causing chemical reactions among said trivalent arsenic oxide compounds, said oxygen gas and said ground goethite, and allowing said chemical reactions to proceed until most of said trivalent arsenic oxide compounds are converted to crystalline scorodite; and
(c) thereafter removing at least a portion of said treated slurry containing crystalline scorodite from said pressurized vessel.

30. The method of claim 29, wherein said oxygen gas used to treat said acidified slurry in said pressurized vessel is provided in an amount sufficient to create an oxygen overpressure between about 75 psi and 200 psi.

31. The method of claim 29, wherein said acidification of said slurry in step a is carried out by the addition of sulfuric acid to said slurry in amounts sufficient to lower and maintain said pH in the solution phase of said slurry between about 0.5 and about 1.0 throughout the course of said chemical reactions in step b in said pressurized vessel, and whereby the dissolution of said goethite into the solution phase of said slurry is enhanced without substantially retarding said precipitation of crystalline scorodite.

32. The method of claim 29, wherein the weight concentration of solids in said acidified slurry in step a is greater than about 15% and less than about 60%.

33. The method of claim 29, wherein said water-soluble nitrate and water-soluble iodide comprising said oxidation catalyst are added to said acidified slurry in step b in amounts of approximately 5 grams of nitrate, expressed as HNO₃, per liter of aqueous phase of said acidified slurry and approximately 0.2 grams of iodide, expressed as KI, per liter of aqueous phase of said acidified slurry.

34. The method of claim 29, wherein said water-soluble nitrate and water-soluble iodide comprising said oxidation catalyst are provided in step b in amounts sufficient to effectively catalyze the oxidation of arsenite to arsenate by oxygen gas and wherein said oxidation is carried out for a retention time of at least 120 minutes.

35. The method of claim 29, wherein said water-soluble nitrate in said oxidation catalyst is selected from the group consisting of nitric acid, sodium nitrate, ammonium nitrate and potassium nitrate.

36. The method of claim 29, wherein said water-soluble iodide in said oxidation catalyst is selected from the group consisting of potassium iodide and sodium iodide.

37. The method of claim 29, wherein approximately 80% by weight of said ground iron-containing mineral is comprised of particles that are smaller than about 74 micrometers.

38. A method for treating wastes containing trivalent arsenic oxide compounds that are separated from gases generated in processes in which sulfide ores containing arsenic compounds are roasted or smelted, said method comprising:
(a) mixing said wastes with water and ground goethite to form an aqueous slurry of said wastes and ground goethite, and acidifying said slurry to a pH of between about 0.5 and 1.0;
(b) treating said acidified slurry with oxygen gas in a stirred pressurized vessel at a temperature of between about 150° C. and about 200° C. and a pressure of between about 150 psia and 400 psia while providing an oxidation catalyst comprised of a water-soluble nitrate and a water-soluble iodide and maintaining the pH of said acidified slurry between about 0.5 and 1.0 thereby causing chemical reactions among said trivalent arsenic oxide compounds, said oxygen gas and said ground goethite, and allowing said chemical reactions to proceed until most of said trivalent arsenic oxide compounds are converted to crystalline scorodite;
(c) thereafter removing at least a portion of said treated slurry containing crystalline scorodite from said pressurized vessel;
(d) mixing said portion of treated slurry removed in step c with an iron salt and with sufficient hydroxide or carbonate base to increase its pH to above about 2.0 while stirring the resultant mixture for a time sufficient to cause additional precipitation of arsenic as crystalline scorodite within said treated slurry; and
(e) removing said treated slurry containing said crystalline scorodite and said additional crystalline scorodite precipitated in step d.

39. The method of claim 38, wherein said acidification of said slurry in step a is carried out by the addition of sulfuric acid to said slurry in amounts sufficient to lower and maintain said pH in the solution phase of said slurry between about 0.5 and about 1.0 throughout the course of said chemical reactions in step b in said pressurized vessel, and whereby the dissolution of said goethite into the solution phase of said slurry is enhanced without substantially retarding said precipitation of crystalline scorodite.

40. The method of claim 38, wherein said iron salt in step d is a ferric salt.

41. The method of claim 38, wherein said iron salt in step d is a ferric salt made in-situ by providing a ferrous salt and an oxidizing agent in amounts sufficient to oxidize said ferrous salt and converts it to said ferric salt.

42. The method of claim 38, wherein the quantity of iron salt provided in step d is greater than about 2 moles of iron per mole of dissolved arsenic in the treated slurry from step b.

43. The method of claim 38, wherein step d is conducted at a temperature higher than about 80° C.
